(19) United States
(12) Patent Application Publication
(10) Pub. No.: US 2021/0230472 A1
(43) Pub. Date: Jul. 29, 2021

(54) ENCAPSULATED FILTERCAKE REMOVAL TREATMENT

(71) Applicant: HALLIBURTON ENERGY SERVICES, INC., Houston, TX (US)

(72) Inventor: Alexandra Clare Morrison, The Woodlands, TX (US)

(21) Appl. No.: 16/644,422

(22) PCT Filed: Apr. 18, 2019
(86) PCT No.: PCT/US2019/028149

§ 371 Date: Mar. 4, 2020

(51) Int. Cl. C09K 8/536; E21B 37/00

(52) U.S. Cl. CPC C09K 8/536; E21B 37/00

(57) ABSTRACT

Systems and methods for treating a subterranean formation with particulate additives that may be useful in removing filtercake and/or mitigating premature fluid loss from the subterranean formation are provided. In some embodiments, the methods include providing a treatment fluid that includes a base fluid and a particulate additive, wherein particulates of the particulate additive each include an enzyme core and a degradable coating that at least partially encapsulates an outer surface of the enzyme core; and introducing the treatment fluid into at least a portion of a subterranean formation.

### BACKGROUND

The present disclosure relates to systems and methods for treating subterranean formations.

Treatment fluids can be used in a variety of subterranean treatment operations. As used herein, the terms “treat,” “treatment,” “treating,” and grammatical equivalents thereof refer to any subterranean operation that uses a fluid in conjunction with achieving a desired function and/or for a desired purpose. Use of these terms does not imply any particular action by the treatment fluid. Illustrative treatment operations can include, for example, fracturing operations, gravel packing operations, acidizing operations, scale dissolution and removal, consolidation operations, filtercake removal operations, and the like.

For example, a treatment fluid may be used to drill a well bore in a subterranean formation or to complete a well bore in a subterranean formation, as well as numerous other purposes. A drilling fluid, often called a “mud,” is a treatment fluid utilized that is circulated in a well bore as the well bore is being drilled into producing formations to minimize damage to the permeability of the formations and their ability to produce hydrocarbons. As another example, a servicing fluid is a treatment fluid utilized when completion operations are conducted in producing formations and when conducting work-over operations in the formations.

Drilling fluids, servicing fluids, and other treatment fluids, inter alia, often deposit a “filtercake” on the walls of well bores within the producing formations to prevent loss of treatment fluids into the formation and solids from entering into the porosities of the formation. At some point after the well bore is drilled, however, it is often desirable to at least partially remove the filtercake from the walls of the well bore, among other reasons, to facilitate cementing operations and/or production in the well. Filtercake generally includes polymers (such as starch and xanthan gum), calcium carbonate, and other solids. Filtercake removal agents, also referred to as breakers, are usually employed to remove the filtercake. The break times are required to be higher than the time needed for completion work, in order to reduce the premature fluid loss of the breaker into the formation. Commonly used filtercake removal agents include organic acids, chelating agents, and/or enzymes. The rate of filtercake removal is sensitive to temperature as well as other factors. Thus, achieving complete filtercake removal during typical oilfield operations can be challenging, especially under suboptimal and/or variable downhole conditions (e.g., temperature, chemical concentrations, pressure). For example, traditional enzyme treatments, although effective at lower temperatures, may react instantly and can cause fluid losses into the wellbore leading to loss of the filtercake removal treatment before complete cake removal has been achieved. Organic acid and chelating agent treatments, while effective at removing the calcium carbonate component of filtercakes, may be less effective at removing the polymer component at lower temperatures. Hence, the sensitivity of various filtercake removal agents to downhole conditions, among other factors, makes it difficult to optimize a filtercake removal agent recipe that suits job requirements.

### BRIEF DESCRIPTION OF THE DRAWINGS

These drawings illustrate certain aspects of some of the embodiments of the present disclosure, and should not be used to limit or define the claims.

FIG. 1 is a diagram illustrating an example of a well bore drilling assembly that may be used in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF CERTAIN EMBODIMENTS

The present disclosure relates to systems and methods for treating subterranean formations. More particularly, the present disclosure relates to particulate additives that may be useful in removing filtercake and/or mitigating premature fluid loss.

The present disclosure provides composite particulate additives for use in removing filtercake and/or premature mitigating fluid loss that include an enzyme core and a degradable coating that encapsulates an outer surface of the enzyme core. The additives of the present disclosure may be mixed with other components (e.g., a base fluid, other filtercake removal agents, other additives, etc.) to form a treatment fluid that is then introduced into at least a portion of a subterranean formation to perform one or more operations therein.

Among the many potential advantages to the methods and compositions of the present disclosure, only some of which are alluded to herein, the additives, methods, compositions, and systems of the present disclosure may provide improved filtercake removal and/or mitigate premature fluid loss, inter alia, because the particulates disclosed herein are less reactive and/or possess delayed reactivity than certain conventional particulate filtercake removal treatments known in the art. As a result, the additives of the present disclosure may provide more thorough filtercake removal compared to conventional filtercake removal treatments. In some embodiments, the additives of the present disclosure may provide more controlled filtercake removal compared to conventional filtercake removal treatments. Additionally, the additives of the present disclosure may require smaller amounts of the additives for similar levels of filtercake removal and/or fluid loss control as compared to conventional filtercake removal treatments. In some embodiments, certain properties of the additives of the present disclosure such as dissolution time, density, and/or pH may be tuned or tailored for particular applications.

The enzyme core may be a particle made of any known enzyme breaker that is active in the treatment fluid (e.g., once exposed to the treatment fluid) and under reservoir conditions for at least as long as catalytic activity is needed. In some embodiments, the enzyme core may include an enzyme that hydrolyzes starch. In some embodiments, the starch enzymes of the enzyme core may be an amylase, glycoamylase, pullulanase, as well as any other starch enzyme breakers known in the art, any modification thereof, and any combination thereof. In some embodiments, the starch enzyme is α-amylase. In some embodiments, the enzyme core may include one or more additional enzyme breakers known in the art to be useful for dissolving filtercake components, such as enzymes that can hydrolyze xanthan, cellulose, guar, scleroglucan, succinoglycan, or any derivative thereof. The term “dissolve” is defined herein to mean that the filtercake can be completely solubilized, or alternatively, solubilized to the extent that the particles are sufficiently reduced in size to permit their removal from the formation by fluids circulated in the formation. The term “derivative” includes any compound that is made from one of the listed compounds, for example, by replacing one atom in the listed compound with another atom or group of atoms, rearranging two or more atoms in the listed compound, ionizing one of the listed compounds, or creating a salt or ester of one of the listed compounds. In some embodiments, the enzyme core may further include any material suitable for stabilizing, maintaining, and/or delaying the catalytic activity of the enzyme contained therein. Examples of materials suitable for stabilizing, maintaining and/or delaying the catalytic activity of the enzyme may include, but are not limited to, calcium chloride, a formate salt, a pH buffer system, and the like, and any combination thereof. Examples of commercially available enzymes that may be suitable for use as an enzyme core in certain embodiments of the present disclosure are the enzyme breaker products sold under the BDF™-447 tradename available from Halliburton.

The degradable coating that encapsulates an outer surface of the enzyme core may include calcium carbonate. The degradable coating may be distributed on the outer surface of the enzyme core in any fashion or form (e.g., as a coating or film, or as distinct clusters or small masses of crystals) and may be disposed on the outer surface of the enzyme core in any amount. In some embodiments, the outer surface of the enzyme core may be at least partially coated with the degradable coating or may be substantially entirely or entirely coated with the degradable coating. The degradable coating may have any suitable thickness, which may be uniform or variable across the outer surface of the enzyme core. For example, in some embodiments, the thickness of the degradable coating may range from about 0.01 μm to about 10 μm, or alternatively about 0.05 μm to about 5 μm, or alternatively about 0.1 μm to about 1 μm, or alternatively about 0.2 μm to about 0.5 μm. A person of skill in the art with the benefit of this disclosure will recognize the appropriate thickness of the degradable coating suitable for a particular embodiment based on, for example, the desired dissolution time of the degradable coating portion of the particulate additive, the desired delay in enzymatic activity, and the like.

The additives of the present disclosure may include particulates of any shape or size that is appropriate for use as a filtercake removal agent, including generally spherical, cylindrical, or irregular shapes. Generally, the particles of such filtercake removal agents have a d50 particle size distribution (which may be measured or determined by, for example, sieve analysis, direct imaging, light scattering, and laser diffraction, and the like, and any combination thereof) of from about 2 μm to about 1600 μm in diameter, or alternatively from about 10 μm to about 1200 μm in diameter, or alternatively from about 15 μm to about 400 μm in diameter, or alternatively from about 18 μm to about 350 μm in diameter, or alternatively from about 20 μm to about 100 μm in diameter, or any subset therebetween. As used herein and in the appended claims, a “d50 particle size distribution” means the value of the particle diameter at which 50% of a sample's mass is smaller than and 50% of a sample's mass is larger than.

The treatment fluids used in the methods and systems of the present disclosure may include any base fluid known in the art, including aqueous base fluids, non-aqueous base fluids, and any combinations thereof. The term “base fluid” refers to the major component of the fluid (as opposed to components dissolved and/or suspended therein), and does not indicate any particular condition or property of that fluids such as its mass, amount, pH, etc. Aqueous fluids that may be suitable for use in the methods and systems of the present disclosure may include water from any source. Such aqueous fluids may include fresh water, salt water (e.g., water containing one or more salts dissolved therein), brine (e.g., saturated salt water), seawater, or any combination thereof. In most embodiments of the present disclosure, the aqueous fluids include one or more ionic species, such as those formed by salts dissolved in water. For example, seawater and/or produced water may include a variety of divalent cationic species dissolved therein. In certain embodiments, the density of the aqueous fluid can be adjusted, among other purposes, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. One of ordinary skill in the art, with the benefit of this disclosure, will recognize when such density and/or pH adjustments are appropriate. Examples of non-aqueous fluids that may be suitable for use in the methods and systems of the present disclosure include, but are not limited to, oils, hydrocarbons (e.g., diesel, mineral oil, or linear olefins and paraffins), organic liquids, and the like. In certain embodiments, the treatment fluids may include a mixture of one or more fluids and/or gases, including but not limited to emulsions (e.g., invert emulsions), foams, and the like.

The additives of the present disclosure may be included in a treatment fluid of the present disclosure in any amount suitable to achieve the desired degree of filtercake removal while mitigating premature fluid loss and/or diversion, either alone or in combination with other filtercake removal additives in the fluid. In some embodiments, the particulate additives of the present disclosure may be included in a treatment fluid in an amount of from about 0.1 pounds per barrel of fluid (“lbs/bbl”) to about 200 lbs/bbl, or alternatively, from about 1 lbs/bbl to about 100 lbs/bbl, or alternatively, from about 60 lbs/bbl to about 90 lbs/bbl, or alternatively, from about 55 lbs/bbl to about 80 lbs/bbl. The amount of the particulate additives of the present disclosure to include in a treatment fluid may vary depending on certain factors that will be apparent to those of skill in the art with the benefit of this disclosure, including but not limited to the porosity of the formation in which the treatment fluid will be used, the pH and temperature conditions of the formation in which the treatment fluid will be used, the presence of other filtercake removal additives in the fluid, and the like. In some embodiments, the amounts/concentrations of the additives of the present disclosure used may be less than the amounts/concentrations of conventional diverting agents or fluid loss additives that would otherwise be necessary to provide complete filtercake removal or the desired amount of filtercake removal.

In certain embodiments, the treatment fluids used in the methods and systems of the present disclosure optionally may include any number of additional additives. Examples of such additional additives include, but are not limited to, salts, surfactants (e.g., water wetting surfactant), acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, H₂S scavengers, CO₂ scavengers, oxygen scavengers, lubricants, viscosifiers, breakers, weighting agents, relative permeability modifiers, resins, wetting agents, coating enhancement agents, additional filtercake removal agents, antifreeze agents (e.g., ethylene glycol), and the like. For example, in some embodiments, the particulate additives of the present disclosure may be used in combination with one or more conventional filtercake removal agents, such as an organic acid, a chelating agent (e.g., ethylenediaminetetraacetic acid (EDTA), glutamic acid diacetic acid (GLDA), and diethylene triamine penta-acetic acid (DTPA), novel polyacidic chelate (NPC)), any derivatives thereof, and the like. For example, the particulate additives of the present disclosure may be used in combination with diethylene glycol diformate. In these embodiments, the particulate additives of the present disclosure may have a substantially similar particle size and/or specific gravity as the conventional filtercake removal agents and/or additives with which they are used. A person skilled in the art, with the benefit of this disclosure, will recognize the types of additives that may be included in the fluids of the present disclosure for a particular application. In certain embodiments, one or more of these additional additives (e.g., an organic acid ester and/or chelating agent) may be added to the treatment fluid and/or activated after the coated enzyme additive has been at least partially hydrated in the fluid.

The particulate additives of the present disclosure may be prepared using any suitable method and/or equipment known in the art at any time prior to their use. Additionally, both the enzyme core and the degradable coating can be prepared to be either dense or porous depending on the desired structure and the properties of the final product using any of these suitable methods and/or equipment known in the art at any time prior to their use. The enzyme core may be formed by any process, such as spray drying, freeze drying, granulation, or the like, or any combination thereof. The degradable coating may be formed on the outer surface of the enzyme core by any suitable means of deposition known in the art at any time prior to their use such as spray coating, dip coating, or the like, or any combination thereof. For example, in some embodiments, the calcium carbonate may be deposited via various nucleation techniques. In some embodiments, an aqueous solution of the degradable coating may be mixed with or sprayed onto the enzyme cores, and then liquid solvent may be evaporated, leaving behind solid calcium carbonate deposited on the enzyme cores.

The treatment fluids of the present disclosure may be prepared using any suitable method and/or equipment (e.g., blenders, mixers, stirrers, etc.) known in the art at any time prior to their use. The treatment fluids may be prepared at least in part at a well site or at an offsite location. In certain embodiments, the additives of the present disclosure and/or other components of the treatment fluid may be metered directly into a base treatment fluid to form a treatment fluid. In certain embodiments, the additives of the present disclosure and/or other components of the treatment fluid may be mixed and/or slurrified with the base fluid. In certain embodiments, the base fluid may be mixed with the additives of the present disclosure and/or other components of the treatment fluid at a well site where the operation or treatment is conducted, either by batch mixing or continuous (“on-the-fly”) mixing. The term “on-the-fly” is used herein to include methods of combining two or more components wherein a flowing stream of one element is continuously introduced into a flowing stream of another component so that the streams are combined and mixed while continuing to flow as a single stream as part of the on-going treatment. Such mixing can also be described as “real-time” mixing. In other embodiments, the treatment fluids of the present disclosure may be prepared, either in whole or in part, at an offsite location and transported to the site where the treatment or operation is conducted. In introducing a treatment fluid of the present disclosure into a portion of a subterranean formation, the components of the treatment fluid may be mixed together at the surface and introduced into the formation together, or one or more components may be introduced into the formation at the surface separately from other components such that the components mix or intermingle in a portion of the formation to form a treatment fluid. In either such case, the treatment fluid is deemed to be introduced into at least a portion of the subterranean formation for purposes of the present disclosure.

The present disclosure in some embodiments provides methods for using the treatment fluids to carry out a variety of subterranean treatments. In some embodiments, the treatment fluids of the present disclosure may be used in treating a portion of a subterranean formation, for example, during or after drilling operations in preparation for production or as a remedial treatment. In certain embodiments, a treatment fluid may be introduced into a subterranean formation. In some embodiments, the treatment fluid may be introduced into a well bore that penetrates a subterranean formation. In some embodiments, the treatment fluid may be contacted with a filtercake that has formed on at least a portion of a subterranean formation (e.g., filtercake removal treatment).

In some embodiments, the additives of the present disclosure may be incorporated into a drilling fluid or servicing fluid that is introduced into at least a portion of a well bore to penetrate at least a portion of the subterranean formation. As the drilling fluid or servicing fluid is circulated, the additives of the present disclosure (either alone or in combination with other particulate additives) may distribute throughout the wellbore portion and/or at least partially remove filtercake from the well bore walls. In some embodiments, the additives of the present disclosure may be incorporated into a relatively small volume of fluid (e.g., about 1000 lbs/bbl or less) such as a drilling fluid, a servicing fluid, or a viscosified gel that is introduced into a portion of a subterranean formation, e.g., a treatment pill such as a lost circulation pill, to remove filtercake and/or to mitigate premature fluid loss. In these embodiments, the fluid carrying the additives of the present disclosure may be pumped to the specific region of interest, and the particulate additives of the present disclosure may be deposited in that region to remove filtercake from that region of the formation and promote and/or divert fluid loss in that region.

In some embodiments, the degradable coating portions of the additives of the present disclosure may be removed using one or more additives. For example, in some embodiments where the degradable coating includes calcium carbonate, the calcium carbonate may be dissolved using one or more acids (e.g., organic acids), acid-releasing materials (e.g., esters), chelating agents, any derivative thereof, and any combination thereof. In these embodiments, the additive used to remove the degradable coating may be added to the treatment fluid at any time. For example, in some embodiments, an organic acid ester (which may react to release one or more acids) may be added to the treatment fluid on-the-fly and then subsequently introduced into the portion of the subterranean formation. In other embodiments, the organic acid ester may be introduced into the portion of the subterranean formation after the particulate additives of the present disclosure are introduced into at least a portion of a wellbore to penetrate at least a portion of the subterranean formation.

After the particulate additives of the present disclosure have performed their function, in some embodiments, they may remain in the formation or may be removed from the formation through any suitable means. For example, in some embodiments, after dissolution of the calcium carbonate and enzymatic activity has been performed, any remaining portions of the enzyme cores may be carried out of the formation, for example, with treatment fluids or other fluids that are flowed back out of the formation, or the enzymes may degrade in the formation over time.

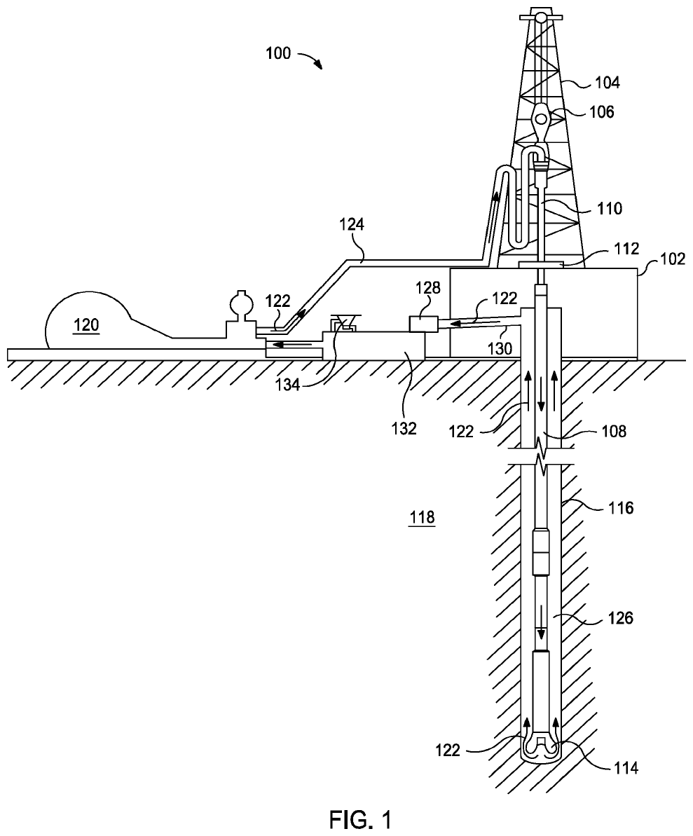

The additives disclosed herein may directly or indirectly affect one or more components or pieces of equipment associated with the preparation, delivery, recapture, recycling, reuse, and/or disposal of the disclosed additives and fluids. For example, and with reference to FIG. 1, the disclosed additives and/or fluids may directly or indirectly affect one or more components or pieces of equipment associated with an example of a wellbore drilling assembly 100, according to one or more embodiments. It should be noted that while FIG. 1 generally depicts a land-based drilling assembly, those skilled in the art will readily recognize that the principles described herein arc equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure. One or more of the disclosed additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed additives may be added to the drilling fluid 122 at any other location in the drilling assembly 100. In at least one embodiment, for example, there could be more than one retention pit 132, such as multiple retention pits 132 in series. Moreover, the retention put 132 may be representative of one or more fluid storage facilities and/or units where the disclosed additives may be stored, reconditioned, and/or regulated until added to the drilling fluid 122.

As mentioned above, the disclosed fluids and/or additives may directly or indirectly affect the components and equipment of the drilling assembly 100. For example, the disclosed fluids and/or additives may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment, and the like. The fluid processing unit(s) 128 may further include one or more sensors, gauges, pumps, compressors, and the like, used store, monitor, regulate, and/or recondition the disclosed fluids and/or additives.

The disclosed fluids and/or additives may directly or indirectly affect the pump 120, which representatively includes any conduits, pipelines, trucks, tubulars, and/or pipes used to fluidically convey the fluids and/or additives downhole, any pumps, compressors, or motors (e.g., topside or downhole) used to drive the fluids and/or additives into motion, any valves or related joints used to regulate the pressure or flow rate of the fluids and/or additives, and any sensors (i.e., pressure, temperature, flow rate, etc.), gauges, and/or combinations thereof, and the like. The disclosed fluids and/or additives may also directly or indirectly affect the mixing hopper 134 and the retention pit 132 and their assorted variations.

The disclosed fluids and/or additives may also directly or indirectly affect the various downhole equipment and tools that may come into contact with the fluids and/or additives such as, but not limited to, the drill string 108, any floats, drill collars, mud motors, downhole motors and/or pumps associated with the drill string 108, and any MWD/LWD tools and related telemetry equipment, sensors, or distributed sensors associated with the drill string 108. The disclosed fluids and/or additives may also directly or indirectly affect any downhole heat exchangers, valves and corresponding actuation devices, tool seals, packers, and other wellbore isolation devices or components, and the like associated with the wellbore 116. The disclosed fluids and/or additives may also directly or indirectly affect the drill bit 114, which may include, but is not limited to, roller cone bits, PDC bits, natural diamond bits, any hole openers, reamers, coring bits, etc. The disclosed fluids and/or additives may also directly or indirectly affect lower completion components installed into the well (not shown).

While not specifically illustrated herein, the disclosed fluids and/or additives may also directly or indirectly affect any transport or delivery equipment used to convey the fluids and/or additives to the drilling assembly 100 such as, for example, any transport vessels, conduits, pipelines, trucks, tubulars, and/or pipes used to fluidically move the fluids and/or additives from one location to another, any pumps, compressors, or motors used to drive the fluids and/or additives into motion, any valves or related joints used to regulate the pressure or flow rate of the fluids and/or additives, and any sensors (i.e., pressure and temperature), gauges, and/or combinations thereof, and the like.

An embodiment of the present disclosure is a method that includes providing a treatment fluid that includes a base fluid and a particulate additive, wherein particulates of the particulate additive each include an enzyme core and a degradable coating that at least partially encapsulates an outer surface of the enzyme core; and introducing the treatment fluid into at least a portion of a subterranean formation.

In one or more of the embodiments described in the preceding paragraph, the degradable coating includes calcium carbonate. In one or more of the embodiments described in the preceding paragraph, the enzyme core includes a starch enzyme. In one or more of the embodiments described in the preceding paragraph, the enzyme core includes an α-amylase. In one or more of the embodiments described in the preceding paragraph, the treatment fluid further includes an additive selected from the group consisting of an organic acid, a chelating agent, any derivative thereof, and any combination thereof. In one or more of the embodiments described in the preceding paragraph, the treatment fluid further includes a chelating agent selected from a group consisting of ethylenediaminetetraacetic acid (EDTA), glutamic acid diacetic acid (GLDA), and diethylene triamine penta-acetic acid (DTPA), novel polyacidic chelate (NPC), any derivative thereof, and any combination thereof. In one or more of the embodiments described in the preceding paragraph, the particulate additive is mixed, slurrified, or mixed and slurrified, with the base fluid. In one or more of the embodiments described in the preceding paragraph, the treatment fluid is a treatment pill having a volume of about 1000 lbs/bbl or less. In one or more of the embodiments described in the preceding paragraph, the particulates have a particle size (d50) of from about 20 μm to about 100 μm in diameter. In one or more of the embodiments described in the preceding paragraph, the degradable coating has a thickness of from about 0.01 μm to about 10 μm. In one or more of the embodiments described in the preceding paragraph, a filtercake is present in at least the portion of the subterranean formation.

Another embodiment of the present disclosure is a method including providing a treatment fluid that includes a base fluid and a particulate additive, wherein particulates of the particulate additive each include an enzyme core and a degradable coating, wherein the degradable coating at least partially encapsulates an outer surface of the enzyme core; and contacting a filtercake in at least a portion of a well bore penetrating a subterranean formation with the treatment fluid. In one or more of the embodiments described in the preceding sentence, the degradable coating includes calcium carbonate.

Another embodiment of the present disclosure is a system including a filtercake removal agent that includes a base fluid; and a plurality of particulates, wherein each of the particulates includes an enzyme core, and a degradable coating that encapsulates an outer surface of the enzyme core.

In one or more embodiments described in the preceding paragraph, the degradable coating includes calcium carbonate. In one or more of the embodiments described in the preceding paragraph, the enzyme core includes a starch enzyme. In one or more of the embodiments described in the preceding paragraph, the enzyme core includes an α-amylase. In one or more of the embodiments described in the preceding paragraph, the filtercake removal agent includes an additive selected from the group consisting of an organic acid, a chelating agent, any derivative thereof, and any combination thereof. In one or more of the embodiments described in the preceding paragraph, the filtercake removal agent includes a chelating agent selected from a group consisting of ethylenediaminetetraacetic acid (EDTA), glutamic acid diacetic acid (GLDA), and diethylene triamine penta-acetic acid (DTPA), novel polyacidic chelate (NPC), any derivative thereof and any combination thereof. In one or more of the embodiments described in the preceding paragraph, the filtercake removal agent includes particulates having a particle size (d50) of from about 20 μm to about 100 μm in diameter.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
providing a treatment fluid that comprises a base fluid and a particulate additive, wherein particulates of the particulate additive each comprise an enzyme core and a degradable coating that at least partially encapsulates an outer surface of the enzyme core; and
introducing the treatment fluid into at least a portion of a subterranean formation.

2. The method of claim 1 wherein the degradable coating comprises calcium carbonate.

3. The method of claim 1 wherein the enzyme core comprises a starch enzyme.

4. The method of claim 1 wherein the enzyme core comprises an α-amylase.

5. The method of claim 1 wherein the treatment fluid further comprises an additive selected from the group consisting of an organic acid, a chelating agent, any derivative thereof, and any combination thereof.

6. The method of claim 1 wherein the treatment fluid further comprises a chelating agent selected from a group consisting of ethylenediaminetetraacetic acid (EDTA), glutamic acid diacetic acid (GLDA), and diethylene triamine penta-acetic acid (DTPA), novel polyacidic chelate (NPC), any derivative thereof, and any combination thereof.

7. The method of claim 1 wherein the particulate additive is mixed, slurrified, or mixed and slurrified, with the base fluid.

8. The method of claim 1 wherein the treatment fluid is a treatment pill having a volume of about 1000 lbs/bbl or less.

9. The method of claim 1 wherein the particulates have a particle size (d50) of from about 20 am to about 100 am in diameter.

10. The method of claim 1 wherein the degradable coating comprises a thickness of from about 0.01 am to about 10 am.

11. The method of claim 1 wherein a filtercake is present in at least the portion of the subterranean formation.

12. A method comprising:
providing a treatment fluid that comprises a base fluid and a particulate additive, wherein particulates of the particulate additive each comprise an enzyme core and a degradable coating, wherein the degradable coating at least partially encapsulates an outer surface of the enzyme core; and
contacting a filtercake in at least a portion of a well bore penetrating a subterranean formation with the treatment fluid.

13. The method of claim 12 wherein the degradable coating comprises calcium carbonate.

14. A filtercake removal agent comprising:
a base fluid; and
a plurality of particulates, wherein each of the particulates comprises
an enzyme core, and
a degradable coating that encapsulates an outer surface of the enzyme core.

15. The filtercake removal agent of claim 14 wherein the degradable coating comprises calcium carbonate.

16. The filtercake removal agent of claim 14 wherein the enzyme core comprises a starch enzyme.

17. The filtercake removal agent of claim 14 wherein the enzyme core comprises an α-amylase.

18. The filtercake removal agent of claim 14 further comprising an additive selected from the group consisting of an organic acid, a chelating agent, any derivative thereof, and any combination thereof.

19. The filtercake removal agent of claim 14 further comprising a chelating agent selected from a group consisting of ethylenediaminetetraacetic acid (EDTA), glutamic acid diacetic acid (GLDA), and diethylene triamine penta-acetic acid (DTPA), novel polyacidic chelate (NPC), any derivative thereof and any combination thereof.

20. The filtercake removal agent of claim 14 wherein the particulates have a particle size (d50) of from about 20 μm to about 100 μm in diameter.
